(19) United States
(12) Patent Application Publication
(10) Pub. No.: US 2025/0128514 A1
(43) Pub. Date: Apr. 24, 2025

(54) LIQUID DISCHARGE HEAD, LIQUID DISCHARGE UNIT, AND LIQUID DISCHARGE APPARATUS

(71) Applicant: Yukio OTOME, KANAGAWA (JP)

(72) Inventor: Yukio OTOME, KANAGAWA (JP)

(21) Appl. No.: 18/918,085

(22) Filed: Oct. 17, 2024

(30) Foreign Application Priority Data
Oct. 19, 2023 (JP) 2023-180630

(51) Int. Cl. B41J 2/14

(52) U.S. Cl. CPC B41J 2/1433; B41J 2/14233; B41J 2202/12

(57) ABSTRACT

A liquid discharge head includes a nozzle plate, multiple individual liquid chambers, a circulation common liquid chamber, a common liquid chamber, a vibration damper, a circulation bridge, and a common bridge. The nozzle plate has multiple nozzles from which a liquid is dischargeable in a liquid discharge direction. The multiple nozzles are arrayed in a nozzle array direction orthogonal to the liquid discharge direction. The vibration damper damps vibration of the liquid in the common liquid chamber. The circulation bridge is bridging the circulation common liquid chamber in an orthogonal direction orthogonal to the nozzle array direction and the liquid discharge direction. The common bridge is bridging the common liquid chamber in the orthogonal direction. The common bridge is disposed at the same position as the circulation bridge in the liquid discharge direction.

### CROSS-REFERENCE TO RELATED APPLICATION

This patent application is based on and claims priority pursuant to 35 U.S.C. § 119 (a) to Japanese Patent Application No. 2023-180630, filed on Oct. 19, 2023, in the Japan Patent Office, the entire disclosure of which is hereby incorporated by reference herein.

### BACKGROUND

### Technical Field

Embodiments of the present disclosure relate to a liquid discharge head, a liquid discharge unit, and a liquid discharge apparatus.

### Related Art

In the related art, a liquid discharge head has the following configuration. The liquid discharge head includes multiple individual liquid chambers respectively communicating with multiple nozzles for discharging liquid, a common liquid chamber communicating with the multiple individual liquid chambers, and a circulation common liquid chamber communicating with the multiple individual liquid chambers. A portion of the common liquid chamber is arranged side by side with the circulation common liquid chamber in an orthogonal direction orthogonal to a nozzle array direction and a liquid discharge direction. A remaining portion of the common liquid chamber, which is a portion other than the portion of the common liquid chamber, includes a portion arranged side by side with the circulation common liquid chamber in the liquid discharge direction, and is wider than the portion of the common liquid chamber in the orthogonal direction. The common liquid chamber includes a vibration damper that damps vibration of the liquid in the common liquid chamber.

### SUMMARY

Embodiments of the present disclosure describe an improved liquid discharge head that includes a nozzle plate, multiple individual liquid chambers, a circulation common liquid chamber, a common liquid chamber, a vibration damper, a circulation bridge, and a common bridge. The nozzle plate has multiple nozzles from which a liquid is dischargeable in a liquid discharge direction. The multiple nozzles are arrayed in a nozzle array direction orthogonal to the liquid discharge direction. The multiple individual liquid chambers respectively communicate with the multiple nozzles. The circulation common liquid chamber communicates with the multiple individual liquid chambers. The common liquid chamber communicates with the multiple individual liquid chambers. The common liquid chamber has a first portion adjacent to the circulation common liquid chamber in an orthogonal direction orthogonal to the nozzle array direction and the liquid discharge direction and a second portion adjacent to the first portion and the circulation common liquid chamber in the liquid discharge direction. The second portion is wider than the first portion in the orthogonal direction. The vibration damper damps vibration of the liquid in the common liquid chamber. The circulation bridge is bridging the circulation common liquid chamber in the orthogonal direction. The common bridge is bridging the common liquid chamber in the orthogonal direction. The common bridge is disposed at a same position as the circulation bridge in the liquid discharge direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external perspective view of a liquid discharge head according to an embodiment of the present disclosure;

FIG. 2 is a cross-sectional view of the liquid discharge head of FIG. 1 in the direction orthogonal to a nozzle array direction;

FIG. 3 is an enlarged cross-sectional view of a portion corresponding to one nozzle of the liquid discharge head of FIG. 1 in the direction orthogonal to an X direction;

FIG. 4 is a partial cross-sectional view of the liquid discharge head in the direction orthogonal to a Y direction, taken along one nozzle row of the liquid discharge head;

FIG. 5 is a cross-sectional view of the liquid discharge head taken along line A-A of FIG. 3;

FIG. 6 is a cross-sectional view of the liquid discharge head taken along line B-B of FIG. 3;

FIG. 7 is a cross-sectional view of the liquid discharge head taken along line C-C of FIG. 2;

FIG. 8 is a perspective cross-sectional view of the liquid discharge head according to the present embodiment;

FIG. 9 is a cross-sectional view of the liquid discharge head taken along line D-D of FIG. 2;

FIG. 10 is a cross-sectional view of the liquid discharge head taken along line E-E of FIG. 2;

FIGS. 11A and 11B are diagrams each illustrating a simulation result of a deformation of a liquid chamber substrate of the liquid discharge head when vibration of the liquid chamber substrate and pressure fluctuations in a common liquid chamber and a circulation common liquid chamber resonate in the liquid discharge head;

FIGS. 12A to 12C are diagrams illustrating three vibration modes of the liquid chamber substrate;

FIGS. 13A and 13B are cross-sectional views of a liquid discharge head according to a modification of the present embodiment;

FIG. 14 is a cross-sectional view of a liquid discharge head according to another modification of the present embodiment;

FIG. 15 is a cross-sectional view of the liquid discharge head taken along line C-C of FIG. 14 from one end to the other end in the Y direction of the liquid discharge head according to the present modification;

FIG. 16 is a cross-sectional view of the liquid discharge head taken along line D-D of FIG. 14 from one end to the other end in the Y direction of the liquid discharge head according to the present modification;

FIG. 17 is a cross-sectional view of the liquid discharge head taken along line E-E of FIG. 14 from one end to the other end in the Y direction of the liquid discharge head according to the present modification;

FIG. 18 is a schematic plan view of a part of a printer according to the present embodiment;

FIG. 19 is a schematic side view of the part of the printer of FIG. 18;

FIG. 20 is a schematic plan view of a part of a liquid discharge unit according to the present embodiment; and

FIG. 21 is a schematic front view of a part of another liquid discharge unit according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. It is to be understood that those skilled in the art can easily modify and change the present disclosure within the scope of the appended claims to form other embodiments, and these modifications and changes are included in the scope of the appended claims. The following embodiments are illustrative and do not limit the scope of the appended claims.

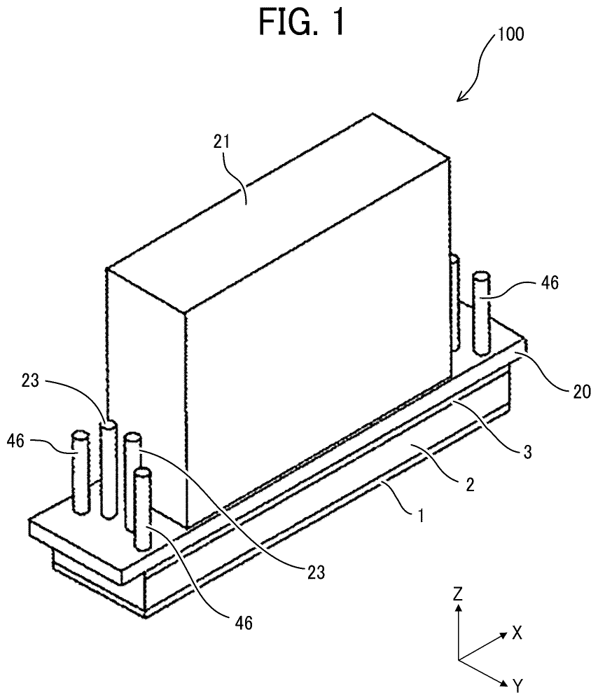

FIG. 1 is an external perspective view of a liquid discharge head 100 according to an embodiment of the present disclosure.

In the following description, a nozzle array direction (longitudinal direction of the liquid discharge head 100) is an X direction, a liquid discharge direction from nozzles (height direction of the liquid discharge head 100) is a Z direction, and a direction orthogonal to both the X direction and the Z direction (transverse direction of the liquid discharge head 100) is a Y direction.

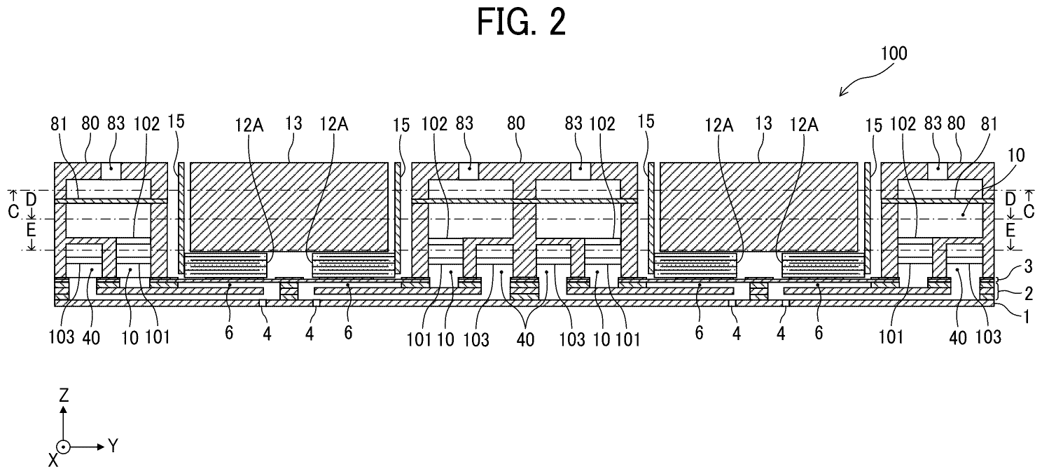

The liquid discharge head 100 includes a nozzle plate 1, a channel plate 2, a diaphragm 3, a liquid chamber substrate 20, and a cover 21. At both ends of the liquid chamber substrate 20 in the X direction, supply ports 23 communicating with common liquid chambers 10 (see FIG. 2) and circulation ports 46 communicating with circulation common liquid chambers 40 (see FIG. 2) are disposed.

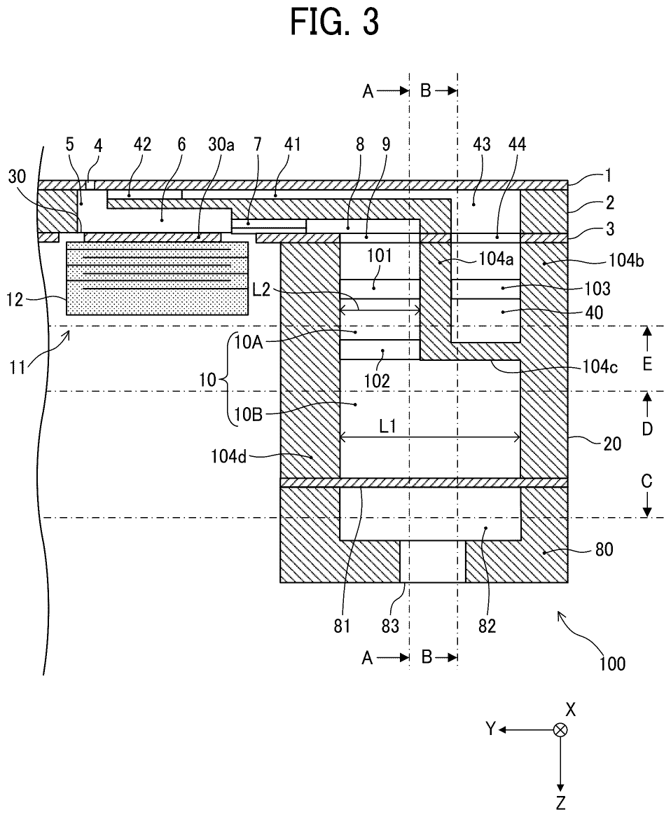

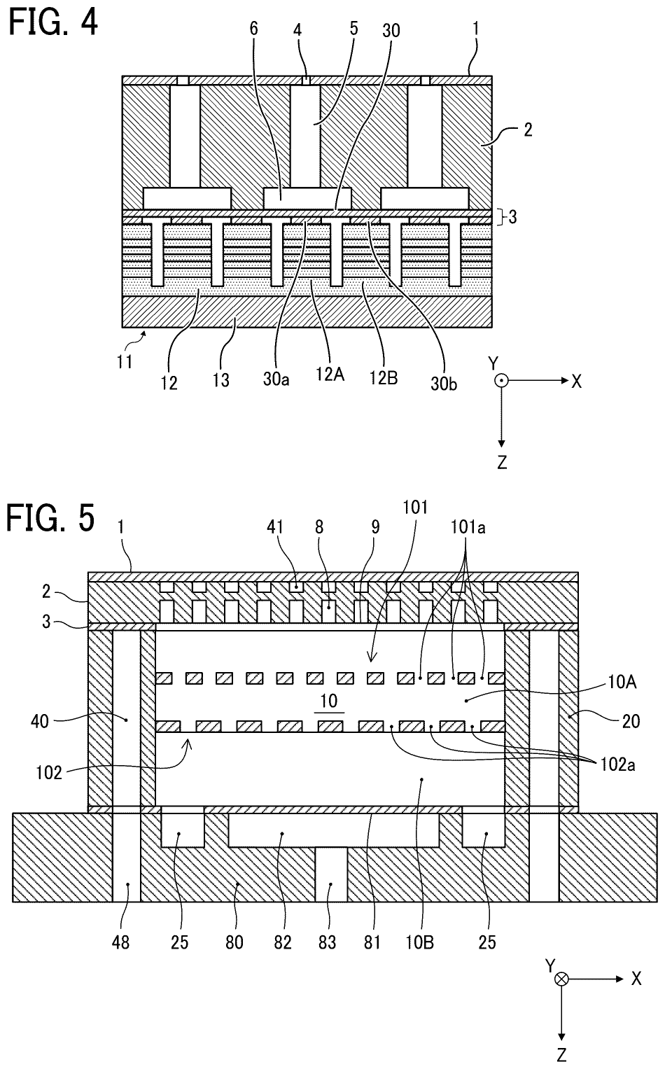

FIG. 2 is a cross-sectional view of the liquid discharge head 100 in the direction orthogonal to the X direction (nozzle array direction), and FIG. 3 is an enlarged cross-sectional view of a portion corresponding to one nozzle 4 of the liquid discharge head 100 in the direction orthogonal to the X direction. FIG. 4 is a partial cross-sectional view of the liquid discharge head 100 in the direction orthogonal to the Y direction, taken along one nozzle row of the liquid discharge head 100.

Although the liquid discharge direction is downward in FIG. 1, the liquid discharge direction is upward in FIGS. 3 and 4.

In the liquid discharge head 100, the nozzle plate 1, the channel plate 2, and the diaphragm 3 are laminated one on another and bonded to each other. A piezoelectric actuator 11 is disposed on the diaphragm 3. The piezoelectric actuator 11 serves as a driver that displaces the diaphragm 3 and also serves as a pressure generator. The nozzle plate 1 has multiple nozzles 4 from which a liquid is discharged in the liquid discharge direction. In the present embodiment, four nozzle rows in which the multiple nozzles 4 are arrayed in the X direction are formed in the nozzle plate 1.

The channel plate 2 forms multiple passages 5 respectively communicating with the multiple nozzles 4, multiple individual liquid chambers 6 respectively communicating with the multiple passages 5, multiple fluid restrictors 7 respectively communicating with the multiple individual liquid chambers 6, and multiple liquid introduction portions 8 respectively communicating with the multiple fluid restrictors 7 (see also FIG. 5). Each of the liquid introduction portions 8 communicates with the common liquid chamber 10 in the liquid chamber substrate 20 via a supply-side opening 9 in the diaphragm 3.

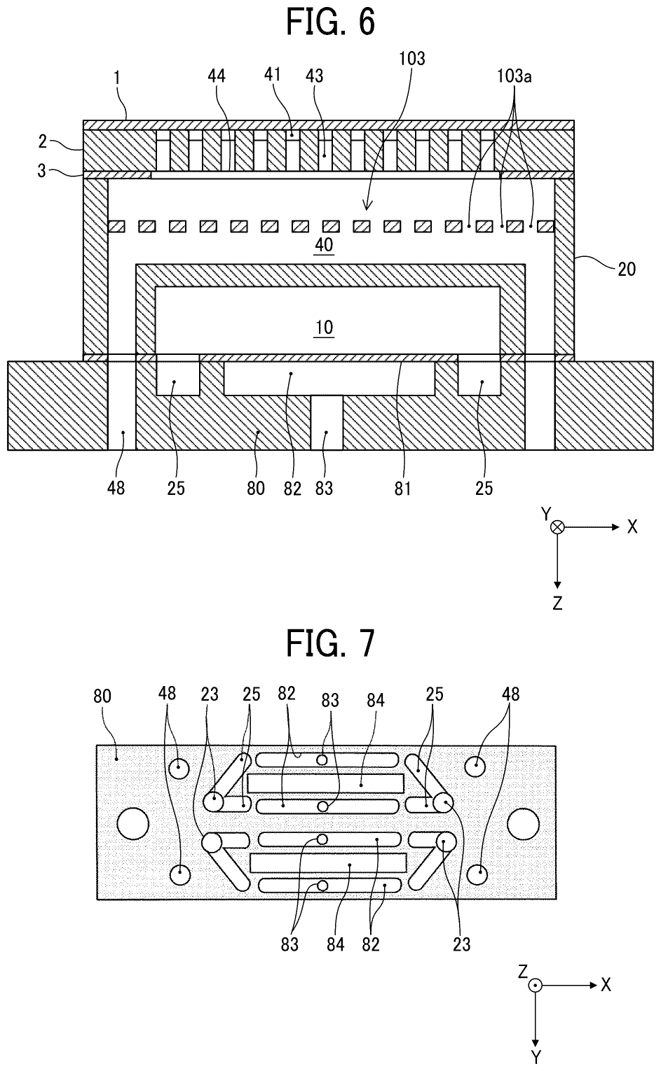

The channel plate 2 also forms multiple circulation fluid restrictors 42 respectively communicating with the multiple passages 5, multiple circulation channels 41 respectively communicating with the multiple circulation fluid restrictors 42, and multiple liquid collection portions 43 respectively communicating with the multiple circulation channels 41 on the nozzle plate 1 side opposite to the individual liquid chambers 6 (see also FIG. 6). Each of the liquid collection portions 43 communicates with the circulation common liquid chamber 40 in the liquid chamber substrate 20 via a circulation-side opening 44 in the diaphragm 3.

The diaphragm 3 defines a wall face of each individual liquid chamber 6 of the channel plate 2. The diaphragm 3 has a two-layer structure including a first layer forming a thin portion and a second layer forming a thick portion from the channel plate 2 side, and a deformable vibration region (diaphragm) 30 is formed in a portion of the first layer corresponding to the individual liquid chamber 6. The diaphragm 3 and the channel plate 2 construct a channel substrate.

The piezoelectric actuator 11 including an electromechanical transducer is disposed opposite to the individual liquid chamber 6 via the diaphragm 3. The piezoelectric actuator 11 includes a piezoelectric member 12 bonded onto a base 13 (see FIG. 2). The piezoelectric member 12 is grooved by half-cut dicing to form a desired number of columnar piezoelectric elements (piezoelectric columns) 12A and 12B at predetermined intervals in a comb shape with respect to one piezoelectric member 12 (see FIG. 4).

In the present embodiment, the piezoelectric element 12A of the piezoelectric member 12 is driven by application of drive waveforms, and the piezoelectric element 12B is merely used as a support to which no drive waveform is applied. Alternatively, all of the piezoelectric elements 12A and 12B can be used as the piezoelectric element to be driven by application of drive waveforms.

The piezoelectric element 12A is bonded to a projection 30a that is an island-shaped thick portion on the vibration region 30 of the diaphragm 3. The piezoelectric element 12B is bonded to a projection 30b that is a thick portion of the diaphragm 3.

The piezoelectric member 12 includes piezoelectric layers and internal electrodes alternately laminated on each other. Each internal electrode is pulled out to the end face to form an external electrode. The external electrode is connected to a flexible wiring 15 as illustrated in FIG. 2.

The liquid chamber substrate 20 is bonded to the diaphragm 3 to form the common liquid chambers 10 and the circulation common liquid chambers 40. The common liquid chamber 10 supplies liquid to the individual liquid chambers 6. Liquid returned from the individual liquid chambers 6 flows into the circulation common liquid chamber 40. As described above, the supply ports 23 communicate with the common liquid chamber 10, and the circulation ports 46 communicate with the circulation common liquid chamber 40.

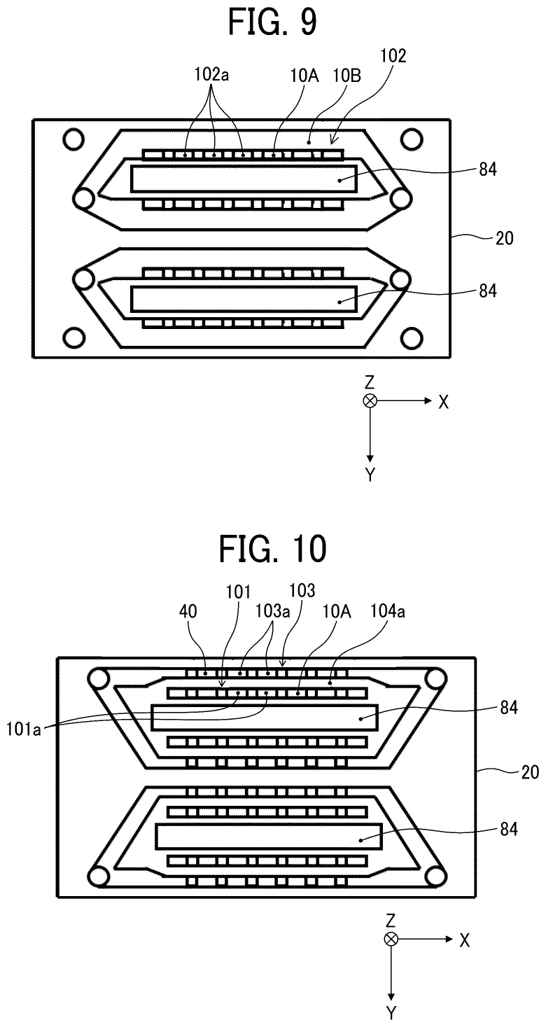

The common liquid chamber 10 at the left end (one end in the Y direction) in FIG. 2 communicates with the second common liquid chamber 10 from the left in FIG. 2 at both ends in the X direction, and the common liquid chamber 10 at the right end (the other end in the Y direction) in FIG. 2 communicates with the second common liquid chamber 10 from the right in FIG. 2 at both ends in the X direction (see FIG. 9).

Similarly, the circulation common liquid chamber 40 at the left end (one end in the Y direction) in FIG. 2 communicates with the second circulation common liquid chamber 40 from the left in FIG. 2 at both ends in the X direction, and the circulation common liquid chamber 40 at the right end (the other end in the Y direction) in FIG. 2 communicates with the second circulation common liquid chamber 40 from the right in FIG. 2 at both ends in the X direction (see FIG. 10).

In the liquid discharge head 100 as described above, for example, when the voltage applied to the piezoelectric element 12A is lowered from a reference potential, the piezoelectric element 12A contracts. Accordingly, the vibration region 30 of the diaphragm 3 moves downward in FIG. 3, and the volume of the individual liquid chamber 6 increases. As a result, the pressure inside the individual liquid chamber 6 becomes negative, and liquid flows into the individual liquid chamber 6.

Then, the voltage applied to the piezoelectric element 12A is raised to expand the piezoelectric element 12A in a lamination direction (Z direction), and the vibration region 30 of the diaphragm 3 is deformed in the direction toward the nozzle 4 to decrease the volume of the individual liquid chamber 6. Thus, liquid in the individual liquid chamber 6 is pressurized and discharged from the nozzle 4.

When the voltage applied to the piezoelectric element 12A is returned to the reference potential, the vibration region 30 of the diaphragm 3 is returned to the initial position. Accordingly, the individual liquid chamber 6 expands to generate a negative pressure, thus replenishing liquid from the common liquid chamber 10 into the individual liquid chamber 6. After the vibration of the meniscus surface of the liquid in the nozzle 4 is damped and stabilized, the liquid discharge head 100 shifts to an operation for the next liquid discharge.

The method of driving the liquid discharge head 100 is not limited to the above-described example (pull-push discharge). For example, pull discharge or push discharge may be performed in accordance with the way to apply a drive waveform.

The liquid that has not been discharged from the nozzle 4 is drained to the circulation common liquid chamber 40 via the multiple circulation channels 41 and the liquid collection portion 43. Then, the liquid is sent from the circulation common liquid chamber 40 to the circulation port 46, and supplied again to the common liquid chamber 10 from the supply port 23 through an external circulation path.

The common liquid chamber 10 and the circulation common liquid chamber 40 in the liquid discharge head 100 of the present embodiment will be described below.

As illustrated in FIG. 3, the common liquid chambers 10 and the circulation common liquid chambers 40 are formed in the liquid chamber substrate 20. The common liquid chamber 10 supplies liquid to the individual liquid chambers 6. Liquid returned from the individual liquid chambers 6 flows into the circulation common liquid chamber 40.

The circulation common liquid chamber 40 is disposed side by side (adjacent to) in the Y direction with a downstream portion 10A (i.e., a first portion) of the common liquid chamber 10 on the downstream side in a liquid flow direction in the common liquid chamber 10. The common liquid chamber 10 includes the downstream portion 10A disposed side by side with the circulation common liquid chamber 40 and an upstream portion 10B (i.e., a second portion) on the upstream side (+Z direction) in the liquid flow direction in the common liquid chamber 10. The upstream portion 10B is a remaining portion, which is a portion of the common liquid chamber 10 other than the downstream portion 10A, positioned farther away from the nozzle plate 1 than the downstream portion 10A.

A portion of the upstream portion 10B of the common liquid chamber 10 is disposed side by side with (adjacent to) the circulation common liquid chamber 40 in the Z direction (disposed opposite to the nozzle plate 1 with respect to the circulation common liquid chamber 40). A width L1 of the upstream portion 10B of the common liquid chamber 10 is wider than a width L2 of the downstream portion 10A of the common liquid chamber 10 in the Y direction (in the following description, referred to simply as the width L1 and the width L2).

As illustrated in FIG. 9, the upstream portion 10B of the common liquid chamber 10 communicates with the adjacent common liquid chamber.

A wall orthogonal to the Z direction of the upstream portion 10B of the common liquid chamber 10 is a damper 81 as a vibration damper that is restorably deformable. The damper 81 is a thin film (i.e., an elastically deformable film), and is sandwiched and held between the liquid chamber substrate 20 and a damper holding substrate 80. The damper 81 as a thin film can be easily bonded to the liquid chamber substrate 20, and thus assembly cost can be reduced.

In the liquid discharge head 100, when a drive waveform is applied to the piezoelectric element 12A to displace the piezoelectric element 12A, a pressure wave (in the following description, referred to as a driving pressure wave) having a cycle of the drive waveform is generated in the individual liquid chamber 6. The driving pressure wave propagates to the common liquid chamber 10 via the fluid restrictor 7 and the liquid introduction portion 8. As driving channels (the number of piezoelectric elements 12A to be displaced) increase, a pressure fluctuation propagating to the common liquid chamber 10 increases.

The damper 81 can damp the pressure fluctuation in the common liquid chamber 10, and thus the influence of the pressure fluctuation propagated from the common liquid chamber 10 to each individual liquid chamber 6 can be reduced. Accordingly, the pressure fluctuation in the individual liquid chamber 6 can be prevented from being disturbed by the pressure fluctuation in the common liquid chamber. As a result, variations in the discharge speed of liquid droplets discharged from the nozzle 4 can be reduced.

The damper holding substrate 80 forms a damper chamber 82 disposed on the side of the damper 81 opposite to the common liquid chamber 10. The damper chamber 82 serves as an allowable chamber that allows deformation of the damper 81, i.e., the damper 81 is deformable in the damper chamber 82. The damper holding substrate 80 has an atmosphere open communication hole 83 communicating with the atmosphere to open the damper chamber 82 to the atmosphere. When the damper 81 is elastically deformed, the damper chamber 82 opened to the atmosphere allows the air in the damper chamber 82 to flow in and out through the atmosphere open communication hole 83, and allows the damper 81 to be elastically deformed favorably. Thus, the damper 81 can favorably damp the pressure fluctuation in the common liquid chamber.

In the common liquid chamber 10, the width L1 of the upstream portion 10B is longer than the width L2 of the downstream portion 10A in the Y direction, and the wall of the upstream portion 10B orthogonal to the Z direction functions as the damper 81. Accordingly, the common liquid chamber 10 has a large damper area of the damper 81. Thus, the damper 81 can favorably prevent the pressure fluctuation in the common liquid chamber 10.

FIG. 5 is a cross-sectional view taken along line A-A of FIG. 3, and FIG. 6 is a cross-sectional view taken along line B-B of FIG. 3. FIG. 7 is a cross-sectional view taken along line C-C in FIG. 2.

The damper holding substrate 80 has communication paths 25 that connect the common liquid chamber 10 and the supply ports 23, and communication paths 48 that connect the circulation common liquid chamber 40 and the circulation ports 46.

The damper 81 has openings corresponding to the communication paths 25 and 48. As illustrated in FIGS. 2 and 7, the liquid chamber substrate 20, the damper 81, and the damper holding substrate 80 have through holes 84 for the piezoelectric actuator 11.

In the liquid discharge head 100 of the present embodiment, since the circulation common liquid chamber 40 and the downstream portion 10A of the common liquid chamber 10 are disposed side by side in the Y direction (transverse direction of the liquid discharge head 100), the length of the liquid discharge head 100 in the Y direction can be reduced as compared with the configuration in which the circulation common liquid chamber 40 and the entire common liquid chamber 10 are arranged side by side.

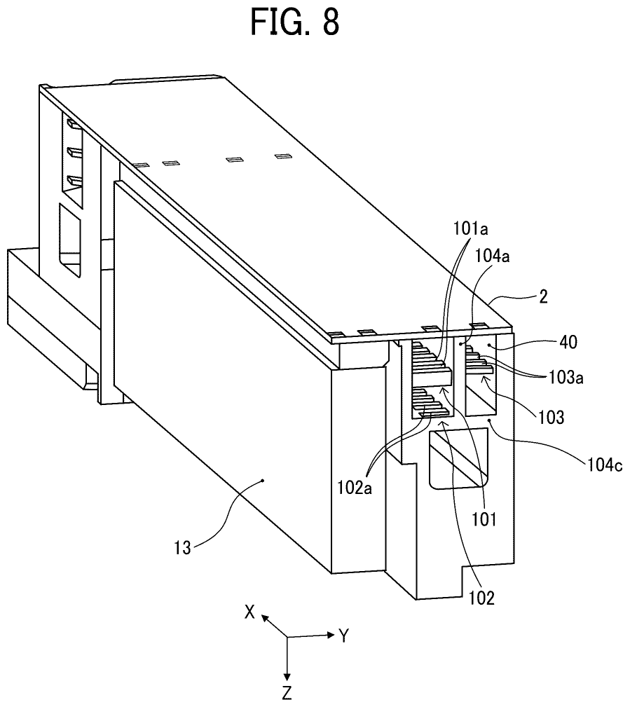

FIG. 8 is a perspective cross-sectional view of the liquid discharge head 100, FIG. 9 is a cross-sectional view taken along line D-D of FIG. 2, and FIG. 10 is a cross-sectional view taken along line E-E of FIG. 2.

In the present embodiment, a circulation common liquid chamber reinforcement bridge 103 (may be referred to simply as a circulation bridge) is disposed at a central portion of the circulation common liquid chamber 40 in the Z direction. The circulation common liquid chamber reinforcement bridge 103 is bridging the circulation common liquid chamber 40 between a wall 104b and a first partition wall 104a, which are a pair of walls of the circulation common liquid chamber 40 orthogonal to the Y direction. The first partition wall 104a separates the downstream portion 10A of the common liquid chamber 10 and the circulation common liquid chamber 40.

The circulation common liquid chamber reinforcement bridge 103 is cut out at predetermined intervals in the X direction to form channels 103a (cutouts) through which liquid flows.

In the common liquid chamber 10, a first common liquid chamber reinforcement bridge 101 and a second common liquid chamber reinforcement bridge 102 (each may be referred to simply as a common bridge) are disposed. The first common liquid chamber reinforcement bridge 101 is disposed at the same position as the circulation common liquid chamber reinforcement bridge 103 in the Z direction. The second common liquid chamber reinforcement bridge 102 is disposed at the same position as a second partition wall 104c in the Z direction. The second partition wall 104c is disposed near the substantially center (i.e., a central portion) of the common liquid chamber 10 in the Z direction and orthogonal to the Z direction to separate the circulation common liquid chamber 40 and the upstream portion 10B of the common liquid chamber in the Z direction.

The first common liquid chamber reinforcement bridge 101 and the second common liquid chamber reinforcement bridge 102 are bridging the common liquid chamber 10 between the first partition wall 104a and the wall 104d of the common liquid chamber 10 adjacent to the piezoelectric member 12. The first common liquid chamber reinforcement bridge 101 and the second common liquid chamber reinforcement bridge 102 are cut out at predetermined intervals in the X direction to form channels 101a and 102a (cutouts) through which liquid flows, respectively.

The intervals and the shapes of the channels 101a, 102a, and 103a and the thicknesses of the reinforcement bridges 101, 102, and 103 are appropriately set based on, for example, the viscosity of liquid used so as to allow the liquid to smoothly flow.

As described above, when a drive waveform is applied to the piezoelectric element 12A, the driving pressure wave is generated in the individual liquid chamber 6, and the driving pressure wave propagates to the common liquid chamber 10 and also to the circulation common liquid chamber 40. As driving channels (the number of piezoelectric elements 12A to be displaced) increase, the pressure fluctuation propagated to the common liquid chamber 10 and the circulation common liquid chamber 40 increases.

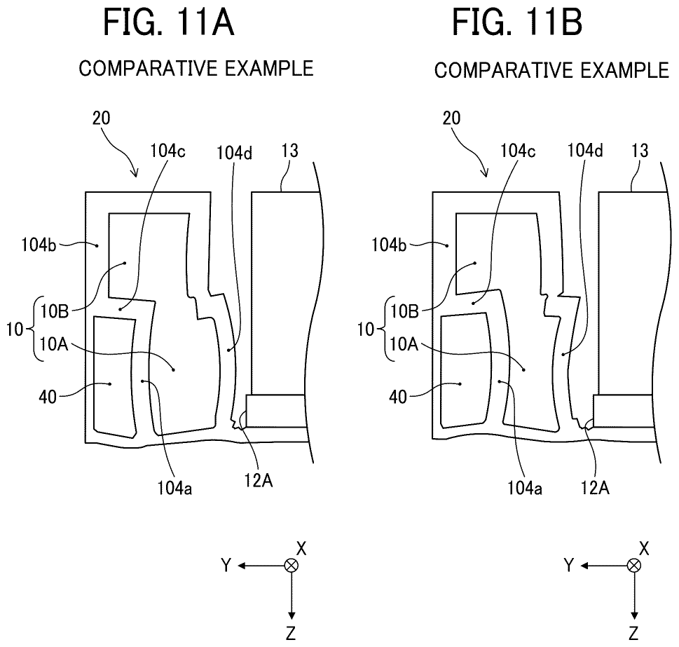

FIGS. 11A and 11B are diagrams each illustrating a simulation result of a deformation of the liquid chamber substrate 20 of a comparative liquid discharge head, which does not have reinforcement bridge, when vibration of the liquid chamber substrate 20 and pressure fluctuations in the common liquid chamber 10 and the circulation common liquid chamber 40 resonate.

In this simulation, the wall 104b of the common liquid chamber 10 on the left side in FIGS. 11A and 11B (the wall on the far side of the common liquid chamber 10 from the piezoelectric member 12) is fixed (not deformed).

As illustrated in FIG. 11A, when the pressure in the common liquid chamber 10 increases and the pressure in the circulation common liquid chamber 40 decreases, a central portion of the first partition wall 104a separating the downstream portion 10A of the common liquid chamber 10 and the circulation common liquid chamber 40 is elastically deformed greatly toward the circulation common liquid chamber 40. Further, the vicinity of the center of the portion of the wall 104d of the common liquid chamber 10, which is adjacent to the piezoelectric member 12 and opposed to the first partition wall 104a, is elastically deformed greatly toward the piezoelectric element 12A (i.e., outward).

When the first partition wall 104a is elastically deformed toward the circulation common liquid chamber 40, and the portion of the wall 104d of the common liquid chamber 10, which is adjacent to the piezoelectric member 12 and opposed to the first partition wall 104a, is elastically deformed outward, the downstream portion 10A of the common liquid chamber 10 expands. By this expansion, the liquid in the upstream portion 10B of the common liquid chamber 10 flows into the downstream portion 10A, and the pressure of the upstream portion 10B of the common liquid chamber 10 becomes negative. Due to this negative pressure, the central portion of the portion of the wall 104d, which is adjacent to the piezoelectric member 12, corresponding to the upstream portion 10B of the common liquid chamber 10 is elastically deformed inward.

As illustrated in FIG. 11B, when the pressure in the common liquid chamber 10 decreases and the pressure in the circulation common liquid chamber 40 increases, the central portion of the first partition wall 104a is elastically deformed greatly toward the common liquid chamber 10.

Further, the vicinity of the center of the portion of the wall 104d of the common liquid chamber 10, which is adjacent to the piezoelectric member 12 and opposed to the first partition wall 104a, is elastically deformed greatly inward.

When the first partition wall 104a is elastically deformed toward the common liquid chamber 10, and the portion of the wall 104d of the common liquid chamber 10, which is adjacent to the piezoelectric member 12 and opposed to the first partition wall 104a, is elastically deformed inward, the downstream portion 10A of the common liquid chamber 10 contracts. By this contraction, the liquid in the downstream portion 10A of the common liquid chamber 10 flows into the upstream portion 10B, and the pressure in the upstream portion 10B of the common liquid chamber 10 increases. As a result, the central portion of the portion of the wall 104d, which is adjacent to the piezoelectric member 12, corresponding to the upstream portion 10B of the common liquid chamber 10 is elastically deformed outward.

As illustrated in FIGS. 11A and 11B, the first partition wall 104a is elastically deformed, and thus the second partition wall 104c separating the circulation common liquid chamber 40 and the upstream portion 10B of the common liquid chamber is also elastically deformed.

As illustrated in FIGS. 1 and 8, the liquid discharge head 100 has a shape elongated in the X direction which is the nozzle array direction, and the common liquid chamber 10 and the circulation common liquid chamber 40 also have a shape longest in the X direction.

Accordingly, the walls 104a, 104b, and 104d, which are orthogonal to the Y direction and long in the X direction, have low rigidity among the walls of the common liquid chamber 10 and the circulation common liquid chamber 40. As a result, as illustrated in FIGS. 11A and 11B, the walls 104a, 104b, and 104d are elastically deformed by the pressure fluctuation propagating to the common liquid chamber 10 and the circulation common liquid chamber 40.

The second partition wall 104c is elastically deformed along with the elastic deformation of the first partition wall 104a, but is not elastically deformed due to the pressure fluctuation. The second partition wall 104c is long in the X direction but quite short in the Y direction, and thus has relatively high rigidity. As a result, the second partition wall 104c is not elastically deformed by the pressure fluctuation.

In FIGS. 11A and 11B, the wall 104b on the far side from the piezoelectric member 12 (i.e., on the left side in FIGS. 11A and 11B) is fixed (not deformed), but the wall 104b on the far side from the piezoelectric member 12 is also long in the X direction and has a certain length in the Z direction, so that the rigidity of the wall 104b is weak. Thus, the center of the portion of the wall of the circulation common liquid chamber 40 in the wall 104b is elastically deformed by the pressure fluctuation of the circulation common liquid chamber 40. In addition, the center of the portion of the wall of the common liquid chamber 10 in the wall 104b on the far side from the piezoelectric member 12 is elastically deformed by the pressure fluctuation of the common liquid chamber 10. The wall 104b on the far side from the piezoelectric member 12 is reinforced by the second partition wall 104c disposed near the center in the Z direction, and the wall 104b is less likely to be elastically deformed than the first partition wall 104a and the wall 104d adjacent to the piezoelectric member 12.

The natural frequency of the liquid chamber substrate 20 is determined by elastic deformation characteristics of the liquid chamber substrate 20, and compliance and inertance of the liquid in the common liquid chamber 10 and the liquid in the circulation common liquid chamber 40, which are in contact with the liquid chamber substrate 20.

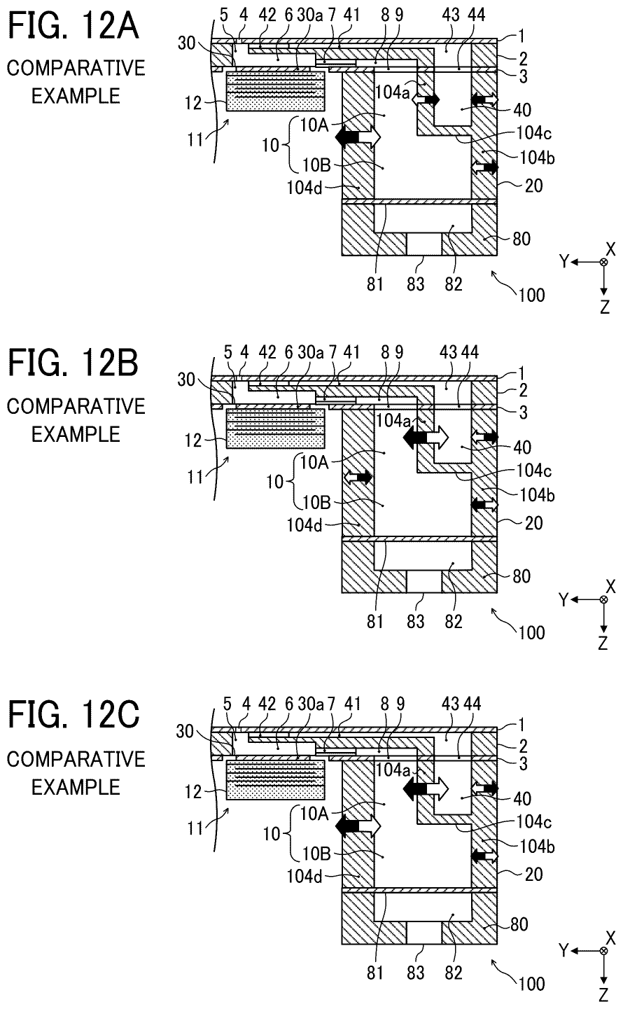

There are the following three types of vibration modes of the liquid chamber substrate 20 of a comparative liquid discharge head, which does not have reinforcement bridge. As illustrated in FIG. 12A, in a first vibration mode, the liquid chamber substrate 20 is vibrated by large elastic deformation of the wall 104d adjacent to the piezoelectric member 12. As illustrated in FIG. 12B, in a second vibration mode, the liquid chamber substrate 20 is vibrated by large elastic deformation of the first partition wall 104a. As illustrated in FIG. 12C, in a third vibration mode, the liquid chamber substrate 20 is vibrated by large elastic deformation of the wall 104d adjacent to the piezoelectric member 12 and the first partition wall 104a. As described above, the liquid chamber substrate 20 has three types of natural frequencies corresponding to the generated three types of vibration modes.

When the cycle of the pressure fluctuation of the liquid in the common liquid chamber 10 and the circulation common liquid chamber 40 is close to the natural frequencies of the above-described three types of vibration modes of the liquid chamber substrates 20, the vibration of the liquid chamber substrate 20 resonates with the pressure fluctuation of the liquid in the common liquid chamber 10 and the circulation common liquid chamber 40. As a result, the vibration of the liquid chamber substrate 20 and the pressure fluctuation of the liquid in the common liquid chamber 10 and the circulation common liquid chamber 40 increase, and the vibration of the liquid chamber substrate 20 and the pressure fluctuation of the liquid in the common liquid chamber 10 and the circulation common liquid chamber 40 propagate to the individual liquid chamber 6. Thus, the desired pressure fluctuation due to the Helmholtz resonance vibration of the liquid in the individual liquid chamber 6 generated by driving the piezoelectric element 12A is greatly disturbed. As a result, the discharge speed of liquid droplets may change or the discharge speed of liquid droplets in the nozzle row may become non-uniform depending on the number of driving channels or the driving frequency. As a result, the landing position of the liquid droplets on a sheet and the print density may vary, causing poor print quality.

Elastic deformation of the walls 104a, 104b, and 104d can be reduced by damping the pressure fluctuation of the common liquid chamber 10 by the damper 81. However, once the wall of the liquid chamber substrate 20 is elastically deformed and the liquid chamber substrate 20 vibrates, and the resonance with the pressure fluctuation of the liquid in the common liquid chamber 10 and the circulation common liquid chamber 40 starts, the vibration of the liquid chamber substrate 20 is not damped by the damper 81. This is because the damper 81 damps the pressure fluctuation in the common liquid chamber, whereas the vibration of the liquid chamber substrate 20 is caused by the resonance generated by the elastic deformation characteristics of the walls, and the compliance and inertance of the liquid in the common liquid chamber 10 and the circulation common liquid chamber 40 as described above. Thus, the generated vibration of the liquid chamber substrate 20 is not damped by the damper 81.

In the present embodiment, the wall 104b on the far side of the circulation common liquid chamber 40 from the piezoelectric member 12 is reinforced by the circulation common liquid chamber reinforcement bridge 103 at the center of the portion of the wall 104b corresponding to the circulation common liquid chamber 40 in the Z direction. The elastic deformation of the wall 104b due to the pressure fluctuation of the circulation common liquid chamber 40 is reduced in the portion of the wall 104b corresponding to the circulation common liquid chamber 40. Thus, the resonance between the liquid chamber substrate 20 and the pressure fluctuation of the liquid in the circulation common liquid chamber 40 is favorably prevented.

The first partition wall 104a, which separates the downstream portion 10A of the common liquid chamber 10 and the circulation common liquid chamber 40, is reinforced by the circulation common liquid chamber reinforcement bridge 103 and the first common liquid chamber reinforcement bridge 101 at the center of the first partition wall 104a in the Z direction. Even if the cycle of the pressure fluctuation of the common liquid chamber 10 and the cycle of the pressure fluctuation of the circulation common liquid chamber 40 are shifted by a half cycle, and one of the common liquid chamber 10 and the circulation common liquid chamber 40 is increased in pressure and the other is decreased in pressure, the elastic deformation of the first partition wall 104a can be favorably prevented. Thus, the vibration of the liquid chamber substrate 20 in the vibration mode of FIG. 12B is reduced, and the resonance between the liquid chamber substrate 20 and the pressure fluctuation of the liquid in the common liquid chamber 10 and the circulation common liquid chamber 40 is favorably prevented.

In the portion of the wall 104d corresponding to the downstream portion 10A of the common liquid chamber 10, the elastic deformation of the wall 104d adjacent to the piezoelectric member 12 can be reduced by the first common liquid chamber reinforcement bridge 101. Thus, expansion and contraction of the downstream portion 10A of the common liquid chamber 10 due to the elastic deformation illustrated in FIGS. 11A and 11B of the first partition wall 104a and the wall 104d adjacent to the piezoelectric member 12 are prevented. As a result, the vibration of the liquid chamber substrate 20 is reduced, and the resonance between the liquid chamber substrate 20 and the pressure fluctuation of the liquid in the common liquid chamber 10 and the circulation common liquid chamber 40 is favorably prevented.

However, the wall 104d adjacent to the piezoelectric member 12 is long in the Z direction. Accordingly, the central portion, in the Z direction, of the wall 104d adjacent to the piezoelectric member 12 is elastically deformed due to the pressure fluctuation of the common liquid chamber 10, and the first common liquid chamber reinforcement bridges 101 alone does not sufficiently prevent the vibration mode of FIG. 12A.

Thus, in the present embodiment, in the common liquid chamber 10, a pair of walls, which are orthogonal to the Y direction, of the common liquid chamber 10 are reinforced by the multiple common liquid chamber reinforcement bridges 101 and 102.

In the present embodiment, since the second partition wall 104c is disposed near the center of the common liquid chamber 10 in the Z direction, the second common liquid chamber reinforcement bridge 102 is disposed at the same position as the second partition wall 104c in the Z direction. Accordingly, the vicinity of the center, in the Z direction, of the wall 104d adjacent to the piezoelectric member 12, which is most easily deformed, is reinforced by the second common liquid chamber reinforcement bridge 102, and the center, in the Z direction, of the wall 104d adjacent to the piezoelectric member 12 can be prevented from being elastically deformed due to the pressure fluctuation of the common liquid chamber 10. Thus, the vibration mode of FIG. 12A and the vibration mode of FIG. 12C are favorably prevented. As a result, the vibration of the liquid chamber substrate 20 can be reduced, and the resonance between the liquid chamber substrate 20 and the pressure fluctuation of the liquid in the common liquid chamber 10 and the circulation common liquid chamber 40 is favorably prevented.

In the present embodiment, the second common liquid chamber reinforcement bridge 102 is disposed at the same position as the second partition wall 104c in the Z direction. The elastic deformation, in the Z direction, of one end, which is close to the piezoelectric member 12, of the second partition wall 104c is prevented by the second common liquid chamber reinforcement bridge 102. As a result, the vibration of the liquid chamber substrate 20 can be reduced, and the resonance between the liquid chamber substrate 20 and the pressure fluctuation of the liquid in the common liquid chamber 10 and the circulation common liquid chamber 40 is favorably prevented.

In the present embodiment, the length of the common liquid chamber 10 in the Z direction is about 6 mm. When the length of the common liquid chamber 10 in the Z direction is about 6 mm, if the second partition wall 104c is within +1.5 mm with respect to the center of the common liquid chamber 10 in the Z direction, the second common liquid chamber reinforcement bridge 102 is preferably disposed at the same position as the second partition wall 104c in the Z direction. Accordingly, elastic deformation of the central portion of the wall 104d adjacent to the piezoelectric member 12 and elastic deformation, in the Z direction, of the one end, which is close to the piezoelectric member 12, of the second partition wall 104c are prevented by the second common liquid chamber reinforcement bridge 102. As a result, the vibration of the liquid chamber substrate 20 can be reduced, and the resonance between the liquid chamber substrate 20 and the pressure fluctuation of the liquid in the common liquid chamber 10 and the circulation common liquid chamber 40 is favorably prevented.

As described above, in the present embodiment, the three reinforcement bridges 101, 102, and 103 can favorably prevent the elastic deformation of the walls 104a, 104b, and 104d, and thus the vibration of the liquid chamber substrate 20 can be favorably prevented. As a result, the resonance between the liquid chamber substrate 20 and the pressure fluctuation of the liquid in the common liquid chamber 10 and the circulation common liquid chamber 40 is favorably prevented. Thus, the disturbance of the Helmholtz resonance vibration of the liquid in the individual liquid chamber 6 due to the resonance between the liquid chamber substrate 20 and the pressure fluctuation of the liquid in the common liquid chamber 10 and the circulation common liquid chamber 40 can be prevented.

Without the damper 81, the discharge speed of liquid droplets may vary or the discharge speed of liquid droplets may become non-uniform in the nozzle row, causing poor print quality due to variations in the landing position of the liquid droplets on the sheet and the print density.

The three reinforcement bridges 101, 102, and 103 can prevent the elastic deformation of the walls 104a, 104b, and 104d, but when the elastic deformation of the walls 104a, 104b, and 104d is prevented, the pressure fluctuation in the common liquid chamber 10 and the circulation common liquid chamber 40 increases. The increased pressure fluctuation in the common liquid chamber 10 is not damped without the damper 81, the pressure fluctuation propagates to the individual liquid chamber 6, and thus the Helmholtz resonance vibration of the liquid in the individual liquid chamber 6 is disturbed.

The damper 81 can damp the pressure fluctuation in the common liquid chamber caused by the reinforcement of the walls 104a and 104b of the common liquid chamber 10. Thus, the disturbance of the pressure fluctuation of each individual liquid chamber 6 caused by the common liquid chamber reinforcement bridges 101 and 102 is also prevented, and the change in the discharge speed of liquid droplets and the non-uniformity of the discharge speed of liquid droplets in the nozzle row can also be prevented.

As described above, the three reinforcement bridges 101, 102, and 103 and the damper 81 can reduce the variations in the landing position of the liquid droplets on the sheet and the print density, and thus poor print quality can be prevented as compared with a comparative liquid discharge head without a reinforcement bridge and a damper.

As the damper 81, for example, a nickel (Ni) electroformed film, a Palladium-nickel (PdNi) electroformed film, and a steel use stainless (SUS) plate can be used. The Ni electroformed film or the PdNi electroformed film as the damper 81 can be formed with a small thickness of 2 to 7 μm (i.e., thin film), and thus a damping effect of the damper 81 on the pressure fluctuation can be enhanced. The PdNi electroformed film as the damper 81 has good durability, wear resistance, and corrosion resistance, has fewer pinholes, and can extend the life thereof.

The SUS plate as the damper 81 with a small thickness of 10 to 20 μm can be mass-produced by rolling, and thus an inexpensive damper having a high damping effect on pressure fluctuation can be provided.

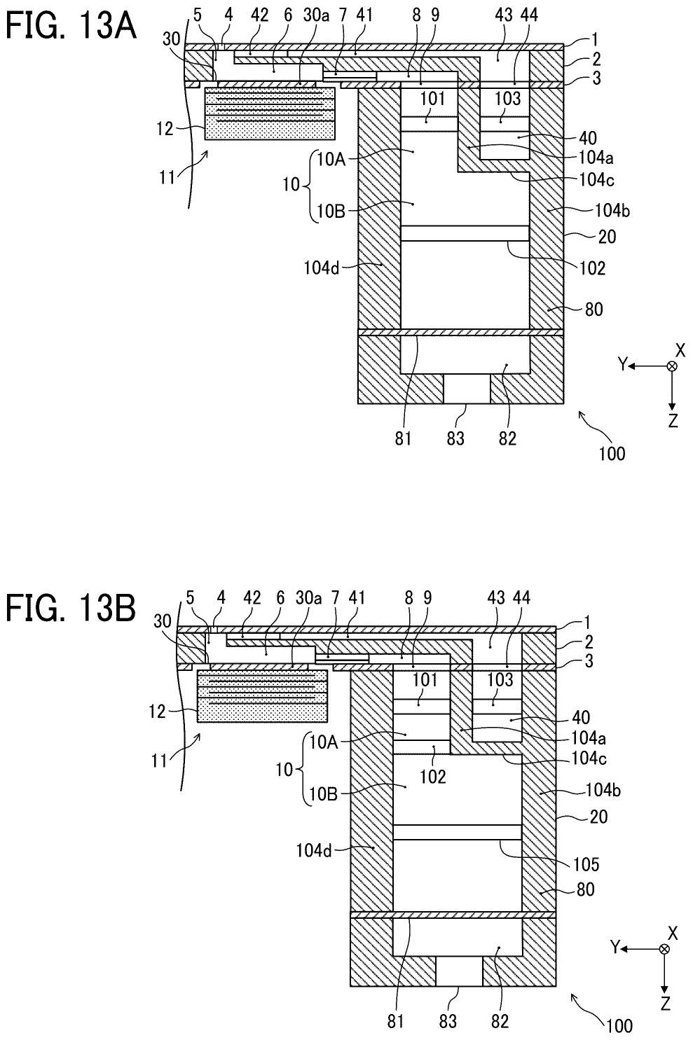

FIGS. 13A and 13B are cross-sectional views of a liquid discharge head according to a modification of the present embodiment.

In the modifications illustrated in FIGS. 13A and 13B, the common liquid chamber 10 is long in the Z direction, and the second partition wall 104c is not disposed near the center of the common liquid chamber 10 in the Z direction. In such a configuration, as illustrated in FIG. 13A, the second common liquid chamber reinforcement bridge 102 is disposed at the central portion of the common liquid chamber 10 in the Z direction. Accordingly, the second common liquid chamber reinforcement bridge 102 can reinforce the central portion, in the Z direction, of the wall 104d adjacent to the piezoelectric member 12 and the central portion, in the Z direction, of the wall 104b on the far side from the piezoelectric member 12, and thus the elastic deformation of the wall 104d adjacent to the piezoelectric member 12 and the wall 104b on the far side from the piezoelectric member 12 is prevented. The wall 104d is most likely to be displaced by the pressure fluctuation of the common liquid chamber 10. As a result, the vibration of the liquid chamber substrate 20 is reduced, and the resonance between the liquid chamber substrate 20 and the pressure fluctuation of the liquid in the common liquid chamber 10 and the circulation common liquid chamber 40 is favorably prevented. Thus, the generation of the vibration mode of the liquid chamber substrate 20 illustrated in FIGS. 12A and 12C can be favorably prevented.

As illustrated in FIG. 13B, the common liquid chamber reinforcement bridges 101, 102, and 105 may be disposed at three positions: the same position as the circulation common liquid chamber reinforcement bridge 103, the same position as the second partition wall 104c, and the position of the central portion, in the Z direction, of the upstream portion 10B of the common liquid chamber 10. As described above, the common liquid chamber reinforcement bridge 101 disposed at the same position as the circulation common liquid chamber reinforcement bridge 103 can prevent the elastic deformation of the first partition wall 104a. The common liquid chamber reinforcement bridge 102 disposed at the same position as the second partition wall 104c can prevent the elastic deformation, in the Z direction, of the one end, which is close to the piezoelectric member 12, of the second partition wall 104c.

The common liquid chamber reinforcement bridge 105 reinforces the central portion, in the Z direction, of the portion of the wall 104d, which is adjacent to the piezoelectric member 12, corresponding to the upstream portion 10B of the common liquid chamber 10 and the portion of the wall 104b, which is on the far side from the piezoelectric member 12, corresponding to the upstream portion 10B of the common liquid chamber 10. Accordingly, the elastic deformation of the central portion, in the Z direction, of the portion of the wall 104d, which is adjacent to the piezoelectric member 12, corresponding to the upstream portion 10B of the common liquid chamber 10 and the central portion, in the Z direction, of the portion of the wall 104b, which is on the far side from the piezoelectric member 12, corresponding to the upstream portion 10B of the common liquid chamber 10 can be prevented. As a result, the vibration of the liquid chamber substrate 20 is favorably reduced, and the resonance between the liquid chamber substrate 20 and the pressure fluctuation of the liquid in the common liquid chamber 10 and the circulation common liquid chamber 40 is favorably prevented.

The configuration of FIG. 13B can favorably prevent the vibration of the liquid chamber substrate 20 as compared with the configuration of FIG. 13A. The configuration of 13A can prevent the pressure fluctuation of the common liquid chamber 10 due to the common liquid chamber reinforcement bridges as compared with the configuration of FIG. 13B. With the configuration of FIG. 13B, when the damper 81 does not sufficiently prevent the pressure fluctuation generated by the multiple common liquid chamber reinforcement bridges depending on, for example, the viscosity of the liquid, the configuration of FIG. 13A is preferable.

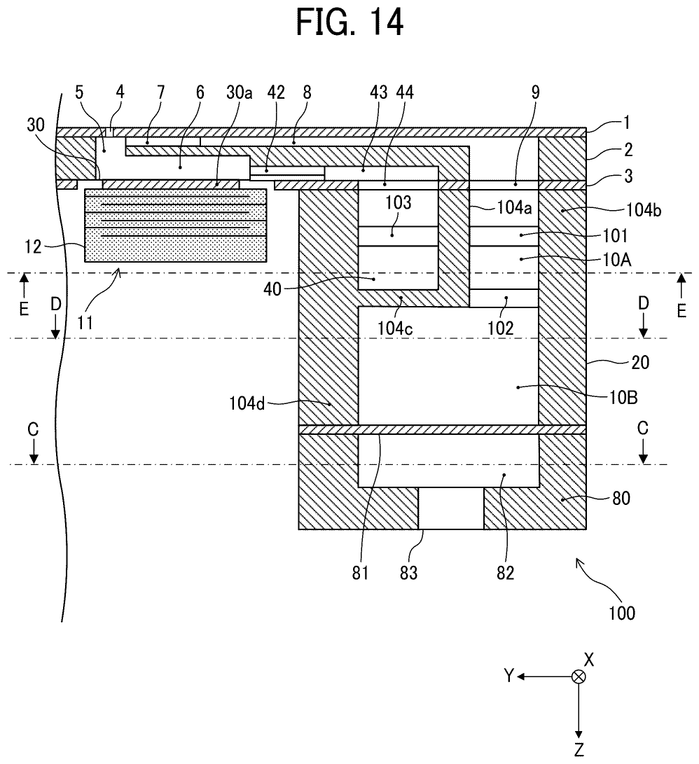

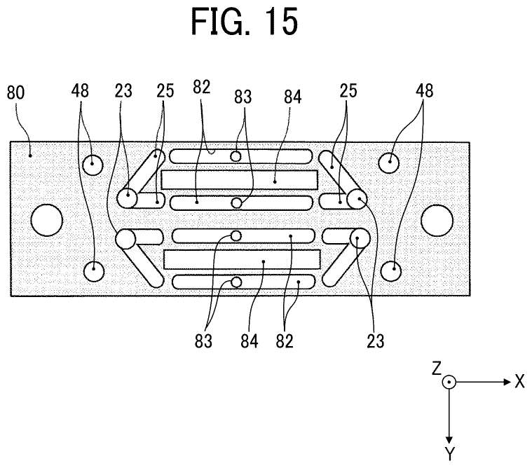

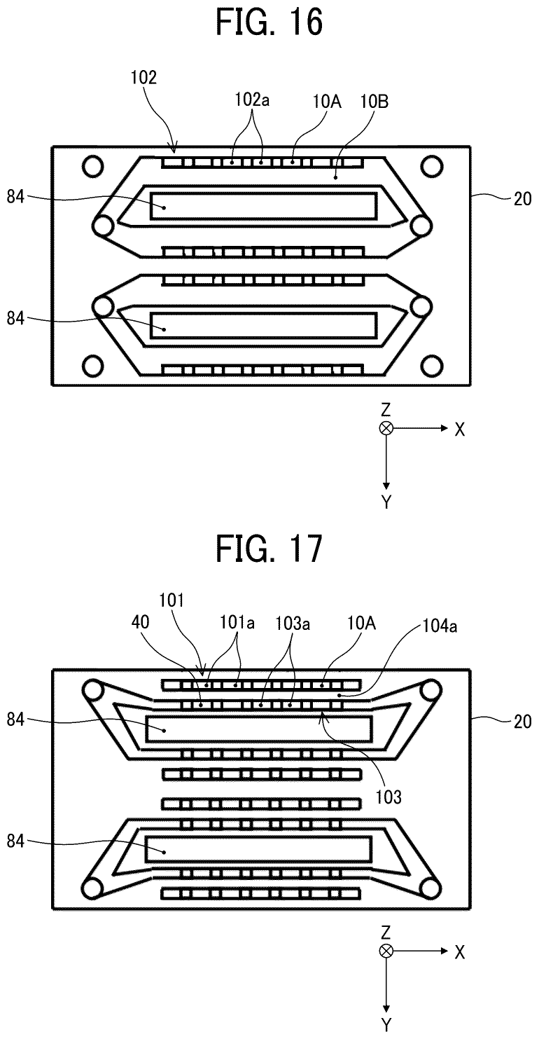

FIG. 14 is a cross-sectional view of a liquid discharge head 100 according to another modification of the present embodiment. FIG. 15 is a cross-sectional view of the liquid discharge head 100 taken along line C-C of FIG. 14 from one end to the other end in the Y direction of the liquid discharge head 100 according to the present modification. FIG. 16 is a cross-sectional view of the liquid discharge head 100 taken along line D-D of FIG. 14 from the one end to the other end in the Y direction of the liquid discharge head 100 according to the present modification. FIG. 17 is a cross-sectional view of the liquid discharge head 100 taken along line E-E of FIG. 14 from the one end to the other end in the Y direction of the liquid discharge head 100 according to the present modification.

In the present modification illustrated in FIGS. 14 to 17, the circulation common liquid chamber 40 is disposed adjacent to the piezoelectric member 12. Also in the present modification, the circulation common liquid chamber reinforcement bridge 103 reinforces the circulation common liquid chamber 40, and the two common liquid chamber reinforcement bridges 101 and 102 reinforce the common liquid chamber 10 to prevent the vibration of the liquid chamber substrate 20. As a result, the resonance between the liquid chamber substrate 20 and the pressure fluctuation of the liquid in the common liquid chamber 10 and the circulation common liquid chamber 40 is favorably prevented. The damper 81 prevents the pressure fluctuation when liquid passes through the channels 101a and 102a of the common liquid chamber reinforcement bridges 101 and 102. Due to such a configuration, the variations in the landing position of the liquid droplets on the sheet and the print density described above can be prevented, and thus poor print quality can be prevented.

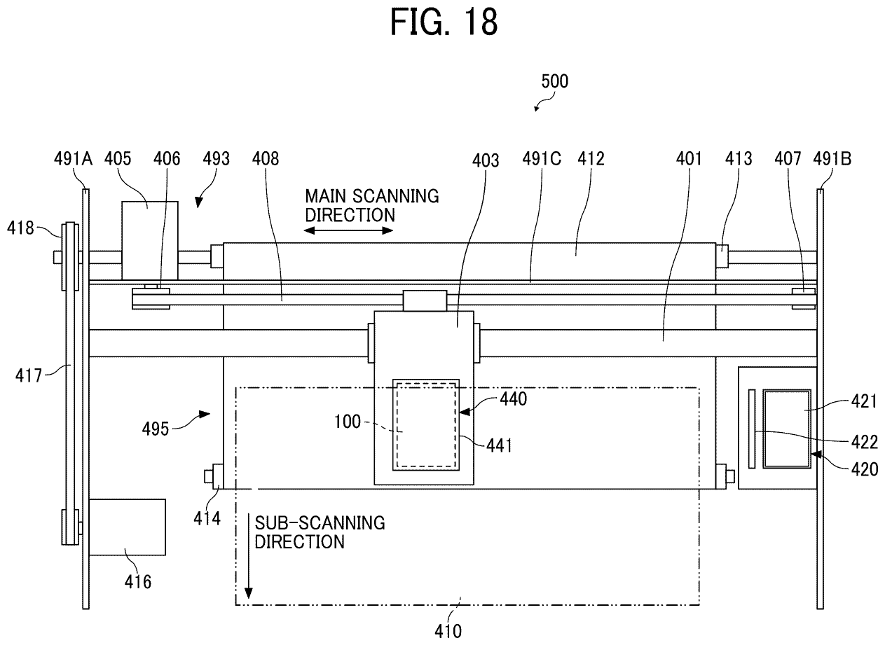

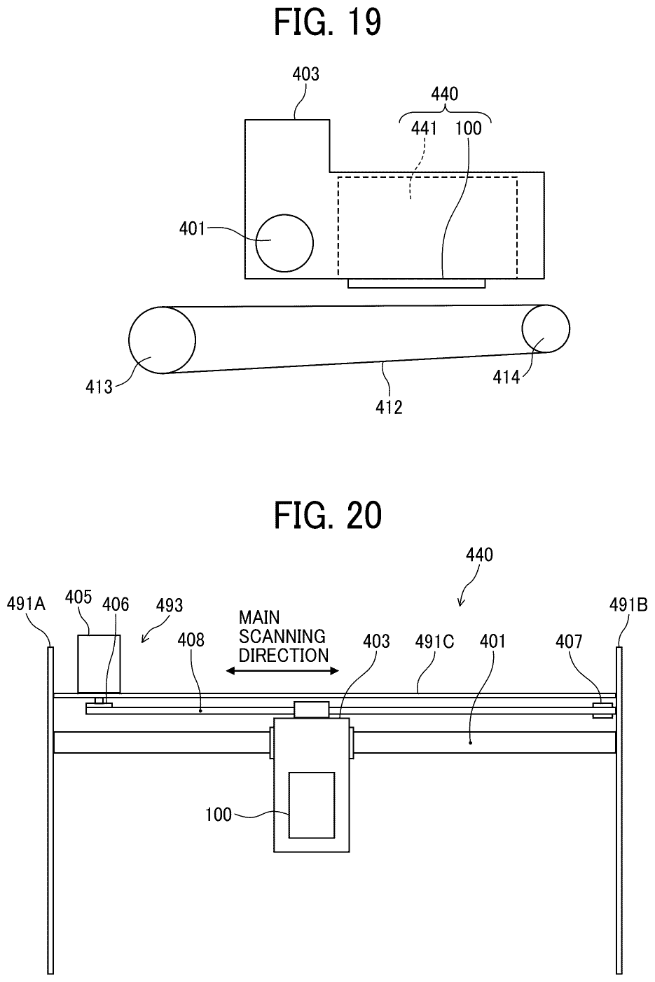

A printer 500 as a liquid discharge apparatus according to an embodiment of the present disclosure is described below with reference to FIGS. 18 and 19.

FIG. 18 is a plan view of a part of the printer 500 according to the present embodiment.

FIG. 19 is a side view of the part of the printer 500 of FIG. 18.

In this example, the printer 500 is a serial type apparatus, and a main-scanning moving mechanism 493 reciprocally moves a carriage 403 in a main scanning direction. The main-scanning moving mechanism 493 includes a guide 401, a main scanning motor 405, and a timing belt 408. The guide 401 is bridged between a left-side plate 491A and a right-side plate 491B to movably hold the carriage 403.

The main scanning motor 405 moves the carriage 403 reciprocally in the main scanning direction via the timing belt 408 bridged between a drive pulley 406 and a driven pulley 407.

The carriage 403 carries a liquid discharge unit 440 in which the liquid discharge head 100 according to the present embodiment and a head tank 441 are integrated as a single unit. The liquid discharge head 100 discharges color liquids of, for example, yellow (Y), cyan (C), magenta (M), and black (K). The liquid discharge head 100 includes a nozzle row in which the multiple nozzles 4 are arrayed in the sub-scanning direction orthogonal to the main scanning direction. The liquid discharge head 100 is mounted on the carriage 403 so that liquid is discharged downward from the nozzles 4. The liquid discharge head 100 is coupled to a liquid circulation device so that a liquid of a desired color is circulated and supplied.

The printer 500 includes a conveyance mechanism 495 to convey a sheet 410 (i.e., a medium). The conveyance mechanism 495 includes a conveyance belt 412 as a conveyor and a sub-scanning motor 416 to drive the conveyance belt 412. The conveyance belt 412 attracts the sheet 410 and conveys the sheet 410 at a position facing the liquid discharge head 100. The conveyance belt 412 is an endless belt looped around a conveyance roller 413 and a tension roller 414. The sheet 410 can be attracted to the conveyance belt 412 by, for example, electrostatic attraction or air suction. The conveyance roller 413 is rotationally driven by the sub-scanning motor 416 via a timing belt 417 and a timing pulley 418 to move the conveyance belt 412 circumferentially in the sub-scanning direction.

On one end of the range of movement of the carriage 403 in the main scanning direction, a maintenance mechanism 420 that maintains and recovers the liquid discharge head 100 is disposed lateral to the conveyance belt 412. The maintenance mechanism 420 includes, for example, a cap 421 to cap a nozzle face of the liquid discharge head 100 and a wiper 422 to wipe the nozzle face. The main-scanning moving mechanism 493, the maintenance mechanism 420, and the conveyance mechanism 495 are mounted onto a housing including the side plates 491A and 491B and a back plate 491C.

In the printer 500 having the above-described configuration, the sheet 410 is fed and attracted onto the conveyance belt 412 and conveyed in the sub-scanning direction by the circumferential movement of the conveyance belt 412. The liquid discharge head 100 is driven in response to image signals while the carriage 403 moves in the main scanning direction to discharge liquid to the sheet 410 not in motion, thus forming an image on the sheet 410.

A liquid discharge unit 440 according to an embodiment of the present disclosure is described below with reference to FIG. 20.

FIG. 20 is a plan view of a part of the liquid discharge unit 440 according to the present embodiment.

The liquid discharge unit 440 includes the housing, the main-scanning moving mechanism 493, the carriage 403, and the liquid discharge head 100 among components of the printer 500 as the liquid discharge apparatus illustrated in FIG. 18. The side plates 491A and 491B, and the back plate 491C construct the housing.

In the liquid discharge unit 440, the maintenance mechanism 420 described above may be mounted on, for example, the side plate 491B.

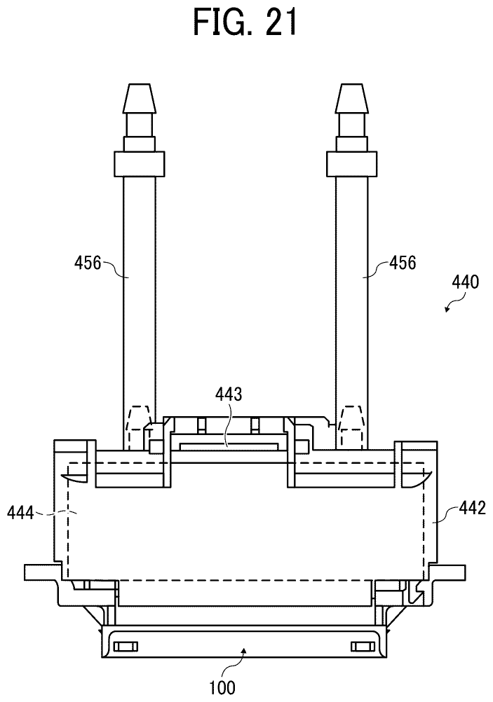

Another liquid discharge unit 440 according to an embodiment of the present disclosure is described below with reference to FIG. 21.

FIG. 21 is a plan view of a part of the liquid discharge unit 440.

The liquid discharge unit 440 includes the liquid discharge head 100 to which a channel component 444 is attached, and a tube 456 connected to the channel component 444.

The channel component 444 is disposed inside a cover 442. Alternatively, the liquid discharge unit 440 may include the head tank 441 instead of the channel component 444. A connector 443 for electrically connecting to the liquid discharge head 100 is disposed on an upper portion of the channel component 444.

In the present disclosure, the liquid to be discharged is not limited to a particular liquid as long as the liquid has a viscosity or surface tension to be discharged from a head (liquid discharge head). However, preferably, the viscosity of the liquid is not greater than 30 millipascal-second (mPa s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The “liquid discharge unit” is an assembly of parts relating to liquid discharge. The term “liquid discharge unit” represents a structure including the liquid discharge head and a functional part(s) or unit(s) combined with the liquid discharge head as a single unit. For example, the “liquid discharge unit” includes a combination of the liquid discharge head with at least one of a head tank, a carriage, a supply mechanism, a maintenance mechanism, a main-scanning moving mechanism, or a liquid circulation device.

The above integration may be achieved by, for example, a combination in which the liquid discharge head and a functional part(s) are secured to each other through, e.g., fastening, bonding, or engaging, and a combination in which one of the liquid discharge head and the functional part(s) is movably held to the other. The liquid discharge head and the functional part(s) or unit(s) may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. The liquid discharge unit may include the liquid discharge head, the carriage, and the main-scanning moving mechanism that are integrated as a single unit.

In still another example, the cap that forms a part of the maintenance mechanism is secured to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head mounting the head tank or the channel component so that the liquid discharge head and the supply mechanism are integrated as a single unit. Through the tubes, the liquid in a liquid storage source is supplied to the liquid discharge head.

The main-scanning moving mechanism may be a guide only. The supply mechanism may be a tube(s) only or a loading device only.

The “liquid discharge unit” includes a head module including the above-described liquid discharge head, and a head unit with which the above-described functional components or mechanisms are combined to form a single unit.

The term “liquid discharge apparatus” used herein also represents an apparatus including the head, the liquid discharge unit, the head module, or the head unit to drive the liquid discharge head to discharge liquid. The liquid discharge apparatus may be, for example, any apparatus that can discharge liquid to a medium to which liquid can adhere or any apparatus to discharge liquid into gas or into liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, and ceramic.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the “liquid discharge apparatus” further include a treatment liquid coating apparatus to discharge a treatment liquid to a sheet to coat a surface of the sheet with the treatment liquid to reform the sheet surface. Examples of the “liquid discharge apparatus” further include an injection granulation apparatus in which a composition liquid including raw materials dispersed in a solution is injected through nozzles to granulate fine particles of the raw materials.

The terms “image formation,” “recording,” “printing,” “image printing,” and “fabricating” used herein may be used synonymously with each other.

The above-described embodiments are illustrative and do not limit the embodiments of the present disclosure. Thus, numerous additional modifications and modifications are possible in light of the above teachings. For example, elements and/or features of different illustrative embodiments may be combined with each other and/or substituted for each other within the scope of the present disclosure.

The configurations according to the above-descried embodiments are examples, and embodiments of the present disclosure are not limited to the above-described examples. For example, the following aspects can achieve effects described below.

### Aspect 1

A liquid discharge head 100 includes multiple individual liquid chambers 6 respectively communicating with multiple nozzles 4 to discharge liquid, a common liquid chamber 10 communicating with the multiple individual liquid chambers 6, a circulation common liquid chamber 40 communicating with the multiple individual liquid chambers 6, and a vibration damper such as a damper 81 that damps vibration of the liquid in the common liquid chamber 10. A portion of the common liquid chamber 10 (a downstream portion 10A of the common liquid chamber 10) is arranged side by side with the circulation common liquid chamber 40 in an orthogonal direction such as a Y direction orthogonal to a nozzle array direction and a liquid discharge direction such as a Z direction. A remaining portion of the common liquid chamber 10 (an upstream portion 10B of the common liquid chamber 10), which is a portion other than the portion of the common liquid chamber 10, includes a portion arranged side by side with the circulation common liquid chamber 40 in the liquid discharge direction. The remaining portion is wider than the portion of the common liquid chamber 10 in the orthogonal direction. The liquid discharge head 100 further includes a circulation common liquid chamber reinforcement bridge 103 bridged in the orthogonal direction at a central portion of the circulation common liquid chamber 40 in the liquid discharge direction and multiple common liquid chamber reinforcement bridges bridged in the orthogonal direction in the common liquid chamber 10. One of the multiple common liquid chamber reinforcement bridges is disposed at the same position as the circulation common liquid chamber reinforcement bridge in the liquid discharge direction.

In other words, a liquid discharge head includes a nozzle plate, multiple individual liquid chambers, a circulation common liquid chamber, a common liquid chamber, a vibration damper, a circulation bridge, and a common bridge. The nozzle plate has multiple nozzles from which a liquid is dischargeable in a liquid discharge direction. The multiple nozzles are arrayed in a nozzle array direction orthogonal to the liquid discharge direction. The multiple individual liquid chambers respectively communicate with the multiple nozzles. The circulation common liquid chamber communicates with the multiple individual liquid chambers. The common liquid chamber communicates with the multiple individual liquid chambers. The common liquid chamber has a first portion adjacent to the circulation common liquid chamber in an orthogonal direction orthogonal to the nozzle array direction and the liquid discharge direction and a second portion adjacent to the first portion and the circulation common liquid chamber in the liquid discharge direction. The second portion is wider than the first portion in the orthogonal direction. The vibration damper damps vibration of the liquid in the common liquid chamber. The circulation bridge is bridging the circulation common liquid chamber in the orthogonal direction. The common bridge is bridging the common liquid chamber in the orthogonal direction. The common bridge is disposed at a same position as the circulation bridge in the liquid discharge direction.

When the liquid is discharged from the nozzle of the individual liquid chamber, a pressure fluctuation occurs in the individual liquid chamber, and this pressure fluctuation propagates to the common liquid chamber and the circulation common liquid chamber. As the number of nozzles that discharge liquid increases among the multiple nozzles, the number of pressure fluctuations propagating from the individual liquid chambers to the common liquid chamber and the circulation common liquid chamber increases, and the pressure fluctuations in the common liquid chamber and the circulation common liquid chamber increase. The liquid discharge head typically has a long shape in the nozzle array direction, and the common liquid chamber and the circulation common liquid chamber also have the longest shape in the nozzle array direction. Thus, the rigidity of the wall orthogonal to the orthogonal direction orthogonal to the nozzle array direction and the liquid discharge direction among the walls of the common liquid chamber and the circulation common liquid chamber is low. Accordingly, due to the pressure fluctuations in the common liquid chamber and the circulation common liquid chamber, walls of the common liquid chamber and the circulation common liquid chamber orthogonal to the orthogonal direction are elastically deformed, and the liquid chamber substrate including the common liquid chamber and the circulation common liquid chamber vibrates. In particular, in a configuration in which a portion of the common liquid chamber and the circulation common liquid chamber are arranged side by side in the orthogonal direction, when the pressure in one of the common liquid chamber and the circulation common liquid chamber increases and the pressure in the other thereof decreases, a central portion, in a discharge direction, of a partition wall orthogonal to the orthogonal direction that separates the portion of the common liquid chamber and the circulation common liquid chamber may be elastically deformed greatly, and vibration of the liquid chamber substrate may increase. The vibration of the liquid chamber substrate resonates with the pressure fluctuations in the common liquid chamber and the circulation common liquid chamber, and the liquid chamber substrate greatly vibrates and the pressure fluctuations in the common liquid chamber and the circulation common liquid chamber increase. The vibration of the liquid chamber substrate and the pressure fluctuation of the liquid in the common liquid chamber 10 and the circulation common liquid chamber 40 propagate to each individual liquid chamber, the pressure fluctuation in the individual liquid chamber is disturbed, and the discharge speed of the liquid droplets discharged from the nozzle may vary.

In Aspect 1, the circulation common liquid chamber reinforcement bridge bridged in the orthogonal direction is disposed at the central portion of the circulation common liquid chamber in the liquid discharge direction. Thus, the central portion of the pair of walls, which are orthogonal to the orthogonal direction, of the circulation common liquid chamber in the liquid discharge direction is reinforced by the circulation common liquid chamber reinforcement bridge, and the deformation of the pair of walls, which are orthogonal to the orthogonal direction, of the circulation common liquid chamber is prevented. The pair of walls of the circulation common liquid chamber are most likely to be deformed by the pressure fluctuation of the circulation common liquid chamber.

A pair of walls of the common liquid chamber are orthogonal to the orthogonal direction, longer in the discharge direction than the circulation common liquid chamber, and reinforced by the multiple common liquid chamber reinforcement bridges bridged in the orthogonal direction. Thus, deformation of the pair of walls, which are orthogonal to the orthogonal direction, of the common liquid chamber due to the pressure fluctuation in the common liquid chamber is prevented.

Since one of the multiple common liquid chamber reinforcement bridges is disposed at the same position as the circulation common liquid chamber reinforcement bridge in the discharge direction, the partition wall orthogonal to the orthogonal direction that separates a portion of the common liquid chamber and the circulation common liquid chamber is reinforced by being sandwiched between the common liquid chamber reinforcement bridge and the circulation common liquid chamber reinforcement bridge. Accordingly, even when the pressure in one of the common liquid chamber and the circulation common liquid chamber increases and the pressure in the other thereof decreases, deformation of the partition wall is favorably prevented.

With the above configuration, the vibration of the liquid chamber substrate caused by the deformation of the walls of the circulation common liquid chamber and the common liquid chamber is prevented. As a result, the resonance between the liquid chamber substrate and the pressure fluctuations in the common liquid chamber and the circulation common liquid chamber is prevented, and the vibration of the liquid chamber substrate and the pressure fluctuation of the liquid in the common liquid chamber 10 and the circulation common liquid chamber 40 due to the resonance are prevented. Thus, the disturbance of the pressure fluctuation in the individual liquid chamber can be prevented. However, disturbance of the pressure fluctuation in the individual liquid chamber caused by the reinforcement bridge has newly generated. Specifically, since the deformation of the wall is prevented by the reinforcement bridge, the pressure fluctuation in the liquid chamber increases. The pressure fluctuation in the liquid chamber propagates to the individual liquid chamber to disturb the pressure fluctuation in the individual liquid chamber, and the variations in the discharge speed of the liquid droplets discharged from the nozzles is not prevented only by the reinforcement bridge.

In Aspect 1, the pressure fluctuation (liquid vibration) in the common liquid chamber caused by the common liquid chamber reinforcement bridge is damped by the vibration damper. Thus, the pressure fluctuation caused by the common liquid chamber reinforcement bridge propagated to the individual liquid chambers can be prevented, and the disturbance of the pressure fluctuation of the individual liquid chambers caused by the common liquid chamber reinforcement bridge can be prevented.

From the above, both the disturbance of the pressure fluctuation of the individual liquid chamber caused by the deformation of the walls of the circulation common liquid chamber and the common liquid chamber and the disturbance of the pressure fluctuation of the individual liquid chamber caused by the reinforcement bridge are prevented, and the variations in the discharge speed of the liquid droplets discharged from the nozzle can be favorably reduced.

### Aspect 2

In Aspect 1, one of the multiple common liquid chamber reinforcement bridges is disposed at the same position as a partition wall such as the second partition wall 104c orthogonal to the liquid discharge direction. The partition wall separates the portion of the remaining portion of the common liquid chamber 10 arranged side by side with the circulation common liquid chamber 40 and the circulation common liquid chamber 40.

In other words, the liquid discharge head according to Aspect 1, further includes a partition wall extending in the orthogonal direction and separating the second portion of the common liquid chamber from the circulation common liquid chamber, and another common bridge disposed at a same position as the partition wall in the liquid discharge direction. With this configuration, as described in the above embodiment, the elastic deformation of the partition wall such as the second partition wall 104c in the discharge direction such as the Z direction can be prevented by the common liquid chamber reinforcement bridge disposed at the same position as the partition wall. Thus, vibration of the liquid chamber substrate 20 including the common liquid chamber and the circulation common liquid chamber can be prevented, and the resonance with the pressure fluctuation of the liquid in the common liquid chamber and the circulation common liquid chamber is favorably prevented.

### Aspect 3

In Aspect 1 or 2, the partition wall such as the second partition wall 104c is disposed near the center of the common liquid chamber 10 in the liquid discharge direction. The number of the common liquid chamber reinforcement bridges is two, one is disposed at the same position as the circulation common liquid chamber reinforcement bridge, and the remaining one is disposed at the same position as the partition wall.

In other words, the partition wall is disposed at a central portion of the common liquid chamber in the liquid discharge direction.

With this configuration, as described in the above embodiment, the central portion of the wall (the wall 104d adjacent to the piezoelectric member 12), which is orthogonal to the orthogonal direction such as the Y direction, of the common liquid chamber can be reinforced by the common liquid chamber reinforcement bridge disposed at the same position as the partition wall, and the elastic deformation of the central portion can be prevented. The wall of the common liquid chamber adjacent to the piezoelectric member is most likely to be displaced by the pressure fluctuation. The common liquid chamber reinforcement bridge disposed at the same position as the partition wall can also prevent the elastic deformation of the partition wall such as the second partition wall 104c in the discharge direction such as the Z direction. Thus, the vibration of the liquid chamber substrate 20 including the common liquid chamber and the circulation common liquid chamber is prevented, and the resonance with the pressure fluctuation of the liquid in the common liquid chamber and the circulation common liquid chamber is favorably prevented.

As compared with a liquid discharge head including three or more common liquid chamber reinforcement bridges, the pressure fluctuation in the common liquid chamber caused by the common liquid chamber reinforcement bridges (pressure fluctuation due to the liquid flowing through the channels of the common liquid chamber reinforcement bridges) can be prevented. Thus, the pressure fluctuation in the common liquid chamber caused by the common liquid chamber reinforcement bridges can be favorably damped by the vibration damper such as the damper 81.

### Aspect 4

In Aspect 1 or 2, one of the multiple common liquid chamber reinforcement bridges is disposed at a central portion in the liquid discharge direction.

In other words, the another common bridges is disposed at a central portion of the common liquid chamber in the liquid discharge direction.

With this configuration, as described in the above embodiment, the central portion of the wall (the wall 104d adjacent to the piezoelectric member 12), which is orthogonal to the orthogonal direction such as the Y direction, of the common liquid chamber can be reinforced by the common liquid chamber reinforcement bridge, and the elastic deformation of the central portion can be prevented. The wall of the common liquid chamber adjacent to the piezoelectric member is most likely to be displaced by the pressure fluctuation. Thus, the vibration of the liquid chamber substrate 20 including the common liquid chamber and the circulation common liquid chamber is prevented, and the resonance with the pressure fluctuation of the liquid in the common liquid chamber and the circulation common liquid chamber is favorably prevented.

### Aspect 5

In any one of Aspects 1 to 4, the vibration damper such as the damper 81 is a thin film (i.e., an elastically deformable film).

With this configuration, the vibration damper such as the damper 81 is elastically deformed favorably by the pressure fluctuation in the common liquid chamber, and the pressure fluctuation in the common liquid chamber can be damped.

### Aspect 6

In Aspect 5, the thin film (i.e., the elastically deformable film) includes a nickel (Ni) electroformed film.

With this configuration, as described in the above embodiment, the thin film can be formed with a thickness of 2 to 7 μm, and the damping effect of the vibration damper on the pressure fluctuation can be enhanced.

### Aspect 7

In Aspect 5, the thin film (i.e., the elastically deformable film) includes a palladium-nickel (PdNi) electroformed film.

With this configuration, as described in the above embodiment, the thin film can be formed with a thickness of 2 to 7 μm, and the damping effect of the vibration damper on the pressure fluctuation can be enhanced. In addition, the thin film has the good durability, wear resistance, and corrosion resistance, has fewer pinholes, and can extend the life thereof.

### Aspect 8

In Aspect 5, the thin film (i.e., the elastically deformable film) includes a steel plate, i.e., a steel use stainless (SUS) plate.

With this configuration, as described in the above embodiment, a thin film with a thickness of 10 to 20 μm can be mass-produced by rolling, and an inexpensive thin film having a high damping effect on pressure fluctuation can be achieved.

### Aspect 9

In any one of Aspects 1 to 8, an allowable chamber such as the damper chamber 82 that allows the deformation of the vibration damper is disposed on a side opposite to the common liquid chamber 10 via the vibration damper such as the damper 81, and the allowable chamber is opened to the atmosphere.

In other words, the liquid discharge head according to any one of Aspects 1 to 8, further includes a damper chamber facing the vibration damper. The damper chamber is disposed opposite the common liquid chamber via the vibration damper. The damper chamber has a hole communicating with an atmosphere.

With this configuration, as described in the above embodiment, the vibration damper such as the damper 81 can be elastically deformed favorably, and the pressure fluctuation in the common liquid chamber can be favorably damped.

### Aspect 10

In a liquid discharge unit including a liquid discharge head, the liquid discharge head according to any one of Aspects 1 to 9 is used as the liquid discharge head.

In other words, a liquid discharge unit includes the liquid discharge head according to any one of Aspects 1 to 9 and a carriage mounting the liquid discharge head to move the liquid discharge head.

With this configuration, a liquid discharge unit can be provided which favorably prevents the variations in the discharge speed of the liquid discharged from the nozzle.

### Aspect 11

In a liquid discharge apparatus such as a printer including the liquid discharge head 100, the liquid discharge head according to any one of Aspects 1 to 9 is used as the liquid discharge head.

In other words, a liquid discharge apparatus includes the liquid discharge head according to any one of Aspects 1 to 9, to discharge a liquid onto a medium and a conveyor to convey the medium.

With this configuration, a liquid discharge apparatus can be provided which discharges liquid with the discharge speed of liquid discharged from the nozzle, the variations of which is favorably prevented.

### Aspect 12

In the liquid discharge head according to Aspect 1, the circulation bridge bridges the circulation common liquid chamber in the orthogonal direction at a central portion of the circulation common liquid chamber in the liquid discharge direction.

### Aspect 13

In the liquid discharge head according to Aspect 2, each of the common bridge, said another common bridge, and the circulation bridge includes cutouts at predetermined intervals in the nozzle array direction, and the cutouts form channels through which the liquid flows.

### Aspect 14

The liquid discharge head according to Aspect 2, further includes multiple common bridges including the common bridge, said another common bridge, and yet another common bridge bridging the second portion of the common liquid chamber in the orthogonal direction.

As described above, according to one aspect of the present disclosure, variations in the discharge speed of liquid discharged from the nozzles can be reliably reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having multiple nozzles from which a liquid is dischargeable in a liquid discharge direction, the multiple nozzles arrayed in a nozzle array direction orthogonal to the liquid discharge direction;
multiple individual liquid chambers respectively communicating with the multiple nozzles;
a circulation common liquid chamber communicating with the multiple individual liquid chambers;
a common liquid chamber communicating with the multiple individual liquid chambers, the common liquid chamber having:
a first portion adjacent to the circulation common liquid chamber in an orthogonal direction orthogonal to the nozzle array direction and the liquid discharge direction; and
a second portion adjacent to the first portion and the circulation common liquid chamber in the liquid discharge direction, and the second portion wider than the first portion in the orthogonal direction;
a vibration damper to damp vibration of the liquid in the common liquid chamber;
a circulation bridge bridging the circulation common liquid chamber in the orthogonal direction; and
a common bridge bridging the common liquid chamber in the orthogonal direction, the common bridge disposed at the same position as the circulation bridge in the liquid discharge direction.

2. The liquid discharge head according to claim 1, further comprising:
a partition wall extending in the orthogonal direction and separating the second portion of the common liquid chamber from the circulation common liquid chamber; and
another common bridge bridging the common liquid chamber in the orthogonal direction, said another common bridge disposed at the same position as the partition wall in the liquid discharge direction.

3. The liquid discharge head according to claim 2,
wherein the partition wall is disposed at a central portion of the common liquid chamber in the liquid discharge direction.

4. The liquid discharge head according to claim 2,
wherein said another common bridge is disposed at a central portion of the common liquid chamber in the liquid discharge direction.

5. The liquid discharge head according to claim 1,
wherein the vibration damper is an elastically deformable film.

6. The liquid discharge head according to claim 5,
wherein the elastically deformable film includes a nickel electroformed film.

7. The liquid discharge head according to claim 5,
wherein the elastically deformable film includes a palladium-nickel electroformed film.

8. The liquid discharge head according to claim 5,
wherein the elastically deformable film includes a stainless plate.

9. The liquid discharge head according to claim 1, further comprising a damper chamber facing the vibration damper,
wherein the damper chamber is disposed opposite the common liquid chamber via the vibration damper, and
the damper chamber has a hole communicating with an atmosphere.

10. A liquid discharge unit comprising:
the liquid discharge head according to claim 1; and
a carriage mounting the liquid discharge head to move the liquid discharge head.

11. A liquid discharge apparatus comprising:
the liquid discharge head according to claim 1, to discharge a liquid onto a medium; and
a conveyor to convey the medium.

12. The liquid discharge head according to claim 1,
wherein the circulation bridge bridges the circulation common liquid chamber in the orthogonal direction at a central portion of the circulation common liquid chamber in the liquid discharge direction.

13. The liquid discharge head according to claim 2,
wherein each of the common bridge, said another common bridge, the circulation bridge includes cutouts at predetermined intervals in the nozzle array direction, and
the cutouts form channels through which the liquid flows.

14. The liquid discharge head according to claim 2, further comprising multiple common bridges including:
the common bridge;
said another common bridge; and
yet another common bridge bridging the second portion of the common liquid chamber in the orthogonal direction.
